(19) United States
(12) Patent Application Publication
(10) Pub. No.: US 2026/0278136 A1
(43) Pub. Date: Sep. 17, 2026

(54) SYSTEM AND METHOD FOR ARTIFICIAL INTELLIGENCE GOVERNANCE PLATFORM FOR RESPONSIBLE ARTIFICIAL INTELLIGENCE

(71) Applicant: PRIVASAPIEN TECHNOLOGIES PRIVATE LIMITED, Bengaluru (IN)

(72) Inventor: Abilash Soundararajan, Bangalore (IN)

(21) Appl. No.: 19/472,887

(22) PCT Filed: Apr. 5, 2024
(86) PCT No.: PCT/IB2024/053330

§ 371 Date: Oct. 7, 2025

(30) Foreign Application Priority Data
Apr. 6, 2023 (IN) 202341025998
Apr. 5, 2024 (WO) PCT/IB2024/053330

(51) Int. Cl. G06F 21/62; G06F 21/57; G06N 3/045

(52) U.S. Cl. CPC G06F 21/6218; G06F 21/577; G06N 3/045; G06F 2221/2111

(57) ABSTRACT

An Artificial Intelligence Governance system, ensuring responsible AI utilization is disclosed. The system features a processing subsystem hosted on a server, orchestrating bidirectional communications across a network among numerous modules. A database module captures and manages diverse activities associated with interacting with Neural network with attention based AI models, while a user input module facilitates user engagement through API or UI. A configuration module defines organizational policies and regulatory requirements, ensuring responsible AI practices. An authentication module regulates user access based on roles, employing granular permission sets. A Neural network with attention based AI governance module uses a pre-trained AI model to classify risks in user prompts. A session management module establishes standardized API endpoints for seamless integration, and a dashboard module offers a summarized overview, governing responsible AI usage within the organization. This system provides transparency, and ethical AI practices across various organizational contexts.

### EARLIEST PRIORITY DATE

This Application claims priority from a Provisional patent application filed in India having Patent Application No. 202341025998, filed on Apr. 6, 2023, and titled “SYSTEM AND METHOD FOR AN AI GOVERNANCE PLATFORM” and a PCT Application no. PCT/IB2024/053330 filed on Apr. 5, 2024, and titled “SYSTEM AND METHOD FOR ARTIFICIAL INTELLIGENCE GOVERNANCE PLATFORM FOR RESPONSIBLE ARTIFICIAL INTELLIGENCE”

### FIELD OF INVENTION

Embodiments of the present disclosure relates to responsible artificial intelligence, and more particularly to, a system and a method for artificial intelligence governance platform for responsible artificial intelligence.

### BACKGROUND

Artificial intelligence has experienced remarkable progress, leading to its pervasive application across diverse domains such as healthcare, finance, education, and autonomous systems. While these advancements bring significant benefits, they also raise ethical challenges and potential risks. Concerns include privacy violation, copyrights violation, sensitive information leak, biased decision-making, lack of transparency, accountability gaps, and unintended consequences. As AI systems become more complex and influential, it becomes crucial to establish a comprehensive governance platform that promotes responsible AI development and deployment. Risk Identification in data being shared with an AI ecosystem, like large language models and Generative AI, may not be sufficient for AI Governance, as it does not provide a perspective on level, velocity, likelihood and severity of risk. Current systems in the market often fall short in providing a comprehensive solution for assessing and managing risks associated with data shared within an AI ecosystem.

While recognizing potential risks is essential, the lack of granularity in evaluating the nature and magnitude of these risks hampers the effectiveness of AI governance platforms. Consequently, there is a pressing need for an innovative solution that goes beyond conventional risk identification, providing a more sophisticated and multifaceted analysis of the risks inherent in AI data sharing. This gap in current systems highlights the necessity for a more comprehensive and nuanced approach to AI governance, one that addresses the evolving landscape of AI technologies and their associated risks in a more detailed manner. Furthermore, the lack of standardization and harmonization across diverse AI technologies complicates the governance landscape. Existing solutions often struggle to provide a unified framework that accommodates the unique characteristics and risks associated with various AI applications. This fragmentation hampers the development of standardized best practices for responsible AI governance.

Hence, there is a need for a system and a method for artificial intelligence governance platform for responsible artificial intelligence to address the aforementioned issue(s).

### OBJECTIVE OF THE INVENTION

An objective of the present invention is to enable seamless interaction and querying of a diverse set of Neural network with attention based AI models within an organization.

Another objective of the present invention is to enable implementation of a user input module to receive input prompts from users via API or UI, enhancing the user experience with Neural network with attention based AI models.

Yet another objective of the invention is to incorporate an adaptive security and privacy layer to dynamically adjust access controls, privacy and sensitive information leak identification during user interactions.

Yet another objective of the present invention is to provide a robust, user-friendly, and comprehensive AI governance platform for responsible AI development and deployment within organizations.

### BRIEF DESCRIPTION

In accordance with an embodiment of the present disclosure, a system for artificial intelligence governance platform for responsible artificial intelligence is provided. The system includes at least one processor in communication with a client processor. The system also includes at least one memory including a set of program instructions in the form of a processing subsystem, configured to be executed by the at least one processor. The processing subsystem is hosted on a server and configured to execute on a network to control bidirectional communications among a plurality of modules. The processing subsystem includes a database module configured to receive, store, and manage a plurality of activities related to the interaction and querying of a plurality of Neural network with attention based artificial intelligence models. The processing subsystem also includes a user input module configured to receive one or more input prompts from a user intending to interact with a single or a plurality of Neural network with attention based artificial intelligence models or generative artificial intelligence models via at least one of an application programming interface (API) and a user interface (UI). The processing subsystem further includes a configuration module configured to define a plurality of organizational policies and regulatory requirements for governing usage of the plurality of Neural network with attention based artificial intelligence models in a responsible way in an organization by defining rules, constraints, and guidelines. The processing subsystem further includes an authentication module configured to regulate and restrict access of one or more users to the plurality of Neural network with attention based artificial intelligence models based on corresponding roles within the organization by providing granular permission sets. The processing subsystem further includes a Neural network with attention based artificial intelligence governance module configured to configured to classify configured risks present in the one or more input prompts received from the user using a pre-trained Neural network with attention based artificial intelligence model. The processing subsystem further includes a session management module configured to facilitate seamless communication and integration with the plurality of downstream artificial intelligence models by defining standardized application programming interface (API) endpoints. The processing subsystem further includes a dashboard module configured to summarize and present information related to the plurality of activities and providing an overview of the responsible usage of the plurality of Neural network with attention based artificial intelligence models within or outside the organization.

In accordance with an embodiment of the present disclosure, a method for artificial intelligence governance platform for responsible artificial intelligence is provided. The method includes receiving, storing, and managing, by a database module, a plurality of activities related to the interaction and querying of a plurality of Neural network with attention based artificial intelligence models. The method further includes receiving, by a user input module, one or more input prompts from a user intending to interact the plurality of Neural network with attention based artificial intelligence models via at least one of an application programming interface (API) and a user interface (UI). The method further includes defining, by a configuration module, a plurality of organizational policies and regulatory requirements for governing usage of the plurality of Neural network with attention based artificial intelligence models in a responsible way in an organization by defining rules, constraints, and guidelines. The method further includes regulating and restricting, by an authentication module, access of one or more users to the plurality of Neural network with attention based artificial intelligence models based on context of the prompt or query, corresponding user's roles within the organization by providing granular permission sets. The method further includes classifying, by a Neural network with attention based artificial intelligence risk visualisation module, risks present in the one or more input prompts received from the user using a pre-trained Neural network with attention based artificial intelligence model. The method further includes facilitating, by a session management module, seamless communication and integration with the plurality of Neural network with attention based artificial intelligence models by defining standardized application programming interface (API) endpoints. The method further includes summarizing, by a dashboard module, and present information related to the plurality of activities and providing an overview of the responsible usage of the plurality of Neural network with attention based artificial intelligence models within the organization.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a computer-implemented system for artificial intelligence governance platform for responsible artificial intelligence in accordance with an embodiment of the present disclosure;

FIG. 2 is a schematic representation of an exemplary embodiment of the computer-implemented system for artificial intelligence governance platform for responsible artificial intelligence of FIG. 1 in accordance with an embodiment of the present disclosure;

FIG. 3 is a block diagram of a computer or a server in accordance with an embodiment of the present disclosure;

FIG. 4 illustrates a flow chart representing the steps involved in a method for artificial intelligence governance platform for responsible artificial intelligence in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated computer-implemented system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, sub-systems, elements, structures, components, additional devices, additional sub-systems, additional elements, additional structures, or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Embodiments of the present disclosure relates to system and method for artificial intelligence governance platform for responsible artificial intelligence. As used herein, Artificial Intelligence refers to the simulation of human intelligence in machines, enabling them to perform tasks that typically require human intelligence, such as visual perception, natural language processing, context understanding, predicting outcomes, making recommendations, prescribing actions, speech recognition, decision-making, and language translation. Further, Governance involves the establishment and implementation of policies, rules, and decision-making processes to guide and control an organization or system. In the context of AI, governance ensures responsible and ethical use of AI technologies. The governance platform is a foundation or framework that provides a base for the development and execution of applications, software, or technologies. In the context of AI, it serves as the infrastructure for managing and deploying AI solutions. A transformer-based AI model refers to an AI based system hosted on a server with processor and memory, which can receive requests or prompts from users and provides responses or completion to those questions based on its training. This may have a transformer-based architecture with attention mechanism to process data. The model may contain just an encoder or both encoder and decoder layers enabling natural language processing. A Neural network with attention based AI model may not have been trained for Privacy Preservation, Accountable usage, User safety, Model Security, Fair and unbiased response, Explainability of its responses and Reliable results. Similarly, as used herein, responsible AI refers to the ethical and accountable development and use of artificial intelligence technologies. It involves ensuring privacy enhancement, safety, security, fairness, transparency, accountability, explainability, reliability and avoiding biases in AI systems. The system and method for artificial intelligence governance platform for responsible artificial intelligence, which can act as a guardrail for generative AI, is further described in detail in the following figure descriptions.

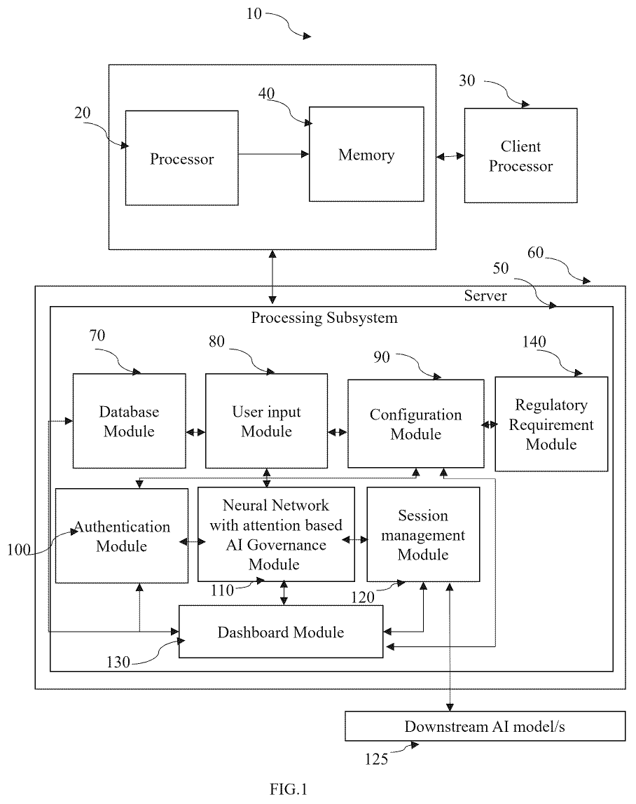

FIG. 1 is a block diagram representation of system 10 for artificial intelligence governance platform for responsible artificial intelligence in accordance with an embodiment of the present disclosure. The system 10 includes at least one processor 20 in communication with a client processor 30. The processor 20 generally refers to a computational unit which can be a central processing unit (CPU) or CPU and Graphics Processing Unit (GPU) responsible for executing instructions in a computer system. The phrase “in communication with a client processor” implies that there is a relationship or interaction between at least one processor and a specific type of processor referred to as a “client processor.” Here, the term “client processor” refer to a processor that initiates requests or tasks and interacts with another processor (which may be a server processor) to fulfil those requests.

The system 10 also includes at least one memory 40 comprises a set of program instructions in the form of a processing subsystem 50, configured to be executed by the at least one processor. The processing subsystem 50 is hosted on a server 60 and configured to execute on a network to control bidirectional communications among a plurality of modules. As used herein, the memory is a storage component within the system used for storing data and instructions that can be accessed by the processor. It executes a sequence of commands or directions written in a programming language that can be executed by a computer. In one embodiment, the server 60 may include a cloud server. In another embodiment, the server 60 may include a local server. The processing subsystem 60 is configured to execute on a network (not shown in FIG. 1) to control bidirectional communications among a plurality of modules. In one embodiment, the network may include a wired network such as local area network (LAN). In another embodiment, the network may include a wireless network such as Wi-Fi, Bluetooth, Zigbee, near field communication (NFC), infra-red communication (RFID) or the like.

The processing subsystem 50 includes a database module 70 configured to receive, store, and manage a plurality of activities related to the interaction and querying of a plurality of Neural network with attention based artificial intelligence models. The database module 70 deals with activities that involve both interactions (communication or engagement) and querying (requesting information) in the context of Neural network with attention based artificial intelligence models. The database module 70 accepts or takes in data, save and retain the received data for future use and it has the capability to organize, control, and oversee the stored data. In one embodiment, the database module 70 is configured to receive responses from one or more Neural network with attention based downstream artificial intelligence models. The responses are stored in a database module 70 for retrieving stored responses from the database and sharing them with the front-end system for user consumption.

Further, the processing subsystem 50 includes a user input module 80 configured to receive one or more input prompts from a user intending to interact the plurality of Neural network with attention based artificial intelligence models via at least one of an application programming interface (API) and a user interface (UI). Users have the purpose of engaging or communicating with the Neural network with attention based artificial intelligence models through this module by receiving multiple prompts, indicating flexibility in user interactions. As used herein, the application programming interface (API) is a set of rules allowing one software application to interact with another. It defines the methods and data formats that applications may use to request and exchange information. APIs are used to enable the integration of different software systems where APIs serve as intermediaries that enable different software applications or systems to interact and share data. They provide a standardized way to access the functionality or data of a particular application, service, or platform without needing to understand its internal workings. Similarly, the user interface (UI) is the point of interaction between the user and the software. It encompasses everything designed into a device or software application that a user may interact with, including screens, pages, buttons, icons, and all visual elements. The primary goal of UI design is to enhance the user experience and make interactions as simple and efficient as possible. UI design focuses on creating interfaces that are visually appealing, intuitive, and user-friendly. It involves considerations such as layout, color schemes, typography, and interactive elements to facilitate smooth and engaging user interactions. The users may interact with the transformer-based AI models either through a programming interface (API), suitable for more technical users, or through a user interface (UI), which provides a more user-friendly interaction. In one embodiment, the user input module 80 is configured to facilitate seamless interaction between the one or more users and the plurality of Neural network with attention based artificial intelligence models, by processing and relaying the one or more inputs prompts to enhance the user experience with the plurality of Neural network with attention based artificial intelligence models.

Moreover, the processing subsystem 50 includes a configuration module 90 configured to define a plurality of organizational policies and regulatory requirements for governing usage of the plurality of Neural network with attention based artificial intelligence models in a responsible way in an organization by defining rules, constraints, and guidelines. More specifically, the configuration module 90 is a component of the artificial intelligence governance platform designed to manage and set parameters that govern the behavior and usage of Neural network with attention based artificial intelligence models within an organization. The configuration module 90 is responsible for defining a set of organizational policies. These policies outline the principles, standards, and guidelines that guide the ethical and responsible use of artificial intelligence models in the organization. The configuration module 90 further addresses regulatory requirements specific to the deployment and operation of artificial intelligence. This involves ensuring compliance with legal standards, industry regulations, and ethical considerations that govern AI usage. The configuration module 90 emphasizes the responsible usage of AI models. This encompasses considerations such as fairness, transparency, accountability, and the mitigation of biases in AI decision-making.

The configuration module 90 establishes rules that govern how the AI models should behave in different scenarios. These rules provide a framework for ethical and compliant AI operations. The configuration module 90 determines constraints which are limitations or boundaries set on the AI models to prevent unintended or unethical behavior. For example, constraints may restrict the use of AI in certain sensitive areas or for specific purposes. The configuration module 90 also sets guidelines which are recommendations or best practices that guide users and developers on how to interact with AI models responsibly. They provide practical advice for achieving ethical and effective AI usage. The configuration module 90 allows organizations to customize policies based on their specific needs, values, and industry requirements. This customization ensures that AI usage aligns with the organization's goals and ethical standards.

In one embodiment, the configuration module 90 is configured to add the security and privacy layer including an adaptive mechanism configured to dynamically adjust access controls and encryption protocols based on the user's interaction with the plurality of Neural network with attention based artificial intelligence models, thereby enhancing user privacy and safeguarding against potential security threats. In detail, the adaptive mechanism within the security and privacy layer is a dynamic system designed to respond and adapt to changes in user interactions with Neural network with attention based artificial intelligence models. The primary purpose of security layer is to enhance security and privacy measures by continuously adjusting settings based on the evolving context and nature of user interactions. Further, the access controls mechanisms regulate which users or systems have access to specific functionalities or data within the artificial intelligence governance platform. The adaptive mechanism dynamically modifies access controls in real-time. For instance, it may tighten access for sensitive operations or loosen restrictions for routine tasks, all contingent on the ongoing user interactions.

In addition, the encryption protocols involve the use of algorithms to encode information, making it unreadable to unauthorized users. The adaptive mechanism dynamically alters encryption protocols based on user interactions. For example, it might strengthen encryption for confidential data exchanges and use lighter encryption for less sensitive communications, adapting to the changing security needs. The security and privacy layer is focused on enhancing user privacy. It considers users as key stakeholders and aims to protect their personal and sensitive information. The adaptive mechanism may provide granular controls over user privacy settings, allowing users to customize and manage the level of privacy protection applied to their interactions. The adaptive mechanism serves as a proactive safeguard against security threats. Security threats include any potential risks or vulnerabilities that could compromise the integrity, confidentiality, or availability of the artificial intelligence system. By dynamically adjusting controls and protocols, it responds to emerging threats, reducing the likelihood of successful attacks or unauthorized access. The security and privacy layer continuously monitors user interactions and system activities in real-time. Based on the real-time monitoring, the adaptive mechanism makes instantaneous adjustments to security and privacy settings, ensuring that the system remains resilient and adaptive to evolving threats and user behaviors. Users may trigger changes in the security and privacy settings based on their preferences or specific requirements.

In a specific embodiment, the configuration module 90 configured to accept configurations from an entity. The configurations define rules of engagement for the one or more users interacting with the plurality of Neural network with attention based artificial intelligence models, thereby allowing customization and specification of user interactions based on the preferences and requirements of the entity. The configuration module 90 is configured to receive configurations from an external entity. The entity may include an organization, business, administrator, or any responsible party that has authority over the system's settings. The configurations provided by the entity define “rules of engagement.” In the context of artificial intelligence models, these rules dictate how users are allowed to interact with the Neural network with attention based artificial intelligence models. The configuration module 90 involves one or more users who interact with Neural network with attention based artificial intelligence models. These users may include developers, data scientists, administrators, students, general public, patient, banker, investor or any individuals involved in using or managing the AI models. The primary function of the configuration module 90 is to allow for customization and specification of user interactions. This means that the entity providing the configurations may tailor how users engage with the AI models according to specific requirements or preferences. The customization of user interactions is based on the preferences and requirements of the entity providing the configurations. These preferences and requirements could encompass a wide range of considerations, including data privacy policies, security protocols, usage constraints, or any other guidelines deemed important by the entity.

In addition, the processing subsystem 50 further includes an authentication module 100 configured to regulate and restrict access of one or more users to the plurality of Neural network with attention based artificial intelligence models based on corresponding roles within the organization by providing granular permission sets. More specifically, authentication is the process of verifying the identity of users attempting to access the system. The primary function of the authentication module 100 is to control and limit access to the Neural network with attention based AI models. It ensures that only authorized users may interact with the AI models while preventing unauthorized access. The authentication module 100 involves multiple users who may interact with the Neural network with attention based AI models. The authentication module 100 refers to a collection or set of Neural network with attention based AI models that are integral to the system. Such Neural network with attention based AI models may perform various tasks such as data analysis, predictions, or decision-making, forming the core functionality of the AI system. Moreover, access to the AI models is regulated based on the roles of users within the organization. The roles define the responsibilities and permissions associated with each user, ensuring that individuals have access only to the resources and functionalities relevant to their designated role.

The authentication module 100 offers granular permission sets, which means that access controls are finely detailed and specific. The users are granted access to specific functionalities or resources based on their roles, and these permissions are finely tuned to match the user's responsibilities within the organization. In one embodiment, the authentication module 100 integrated with the one or more entities authentication module, configured to derive responsible artificial intelligence-based engagement requirement policies for the one or more users based on corresponding roles, thereby facilitating personalized and role-specific interactions with the plurality of Neural network with attention based artificial intelligence models. In particular, primary function of the authentication module is to verify the identity of users attempting to access the system, ensuring that only authorized users interact with the system. The authentication module is designed to work in conjunction with the authentication modules of one or more external entities. These entities could be organizations, businesses, or other systems that have their own authentication mechanisms. The authentication module 100 is configured to derive policies for responsible artificial intelligence-based engagement requirements. Such policies are rules or guidelines that dictate how users can responsibly engage with the Neural network with attention based artificial intelligence (AI) models. This may include ethical considerations, regulatory compliance, or other responsible AI practices. The authentication module 100 involves multiple users who interact with the Neural network with attention based AI models. The derived policies are applied to these users, ensuring that their engagements align with responsible AI practices. The derived policies are specifically tailored to each user based on their corresponding roles within the organization. The roles define the responsibilities and permissions associated with each user, and the policies are customized to match the ethical and responsible engagement requirements relevant to their roles.

Further, the processing subsystem 50 includes a Neural network with attention based artificial intelligence governance module 110 configured to configured to classify configured risks present in the one or more input prompts received from the user and the query response from the downstream AI model/s using a pre-trained Neural network with attention based artificial intelligence model. The Neural network with attention based artificial intelligence governance module 110 is responsible for visualizing or representing identified risks and often present information in a graphical or easily interpretable format. The Neural network with attention based artificial intelligence-based Neural network with attention based artificial intelligence governance module 110 is configured to perform risk classification. This involves the categorization or identification of different types of risks within the input data. The term “configured risks” suggests that the Neural network with attention based artificial intelligence governance module 110 is designed to recognize specific types of risks as configured or predefined by the system. The input prompts refer to the information or requests received from users. These prompts may include text, images, or other forms of input that users provide to the system. The query responses or completions refer to answers provided by downstream or external artificial intelligence models 125 or large language models or other transformer-based models as response to the initial query by the user. These downstream or downstream AI models are external to the system but may be internal or external to the deploying organization. The risk in these responses can be biased or harmful which may be flagged by Neural network with attention based artificial intelligence governance module 110.

The Neural network with attention based artificial intelligence risk visualization module may be a small language model, which is an efficient model compared to the popular large language model. Small language model may have lesser number of parameters, lesser layers, smaller layers sizes, lesser attention heads and hence may have lesser compute requirement and hence more sustainable and environment friendly. Small Language model can be used for specific function like risk visualization for responsible artificial intelligence for both prompt level and completion level harm detection and mitigation.

The input prompts are submitted by users interacting with the system and the responses are provided by downstream AI models. The users may input data, queries, or requests, and the Neural network with attention based artificial intelligence governance module 110 is designed to analyze and classify potential risks within this user-generated content to prevent outflow of sensitive or unauthorized information to an external AI system. The downstream AI models may give prompt responses which may be biased or harmful for users. The Neural network with attention based artificial intelligence governance module 110 leverages a pre-trained and fine-tuned Neural network with attention based artificial intelligence (AI) model and sits in line between user's input going to a downstream AI model and response from downstream AI model going back to the user. Here, pre-training involves training an artificial intelligence model on a large dataset before fine-tuning it for specific tasks. In this context, the Neural network with attention based artificial intelligence model likely possesses general knowledge or capabilities that are fine-tuned to aid in risk identification.

In one embodiment, the Neural network with attention based artificial intelligence governance module 110 is configured to designate the pretrained Neural network with attention based artificial intelligence model to receive user prompts or AI model response as input, featuring a risk identification module responsible for classifying configured risks, and the Neural network with attention based artificial intelligence governance module 110 that shares the output, providing a comprehensive risk analysis based on customer inputs. Furthermore, the Neural network with attention based artificial intelligence governance module 110 often uses graphical representations or other intuitive formats to make complex information more understandable. The Neural network with attention based artificial intelligence governance module 110 is configured to assign or designate a pretrained Neural network with attention based artificial intelligence model for processing and analyzing user prompts to identify risks. The designated pretrained model is set up to receive user prompts or Neural network with attention based AI model response as input. User prompts represent the information, queries, or requests submitted by users interacting with the system. Neural network with attention based AI responses represent answers provided by external AI systems for user queries, which may have biases or other harmful risks. The Neural network with attention based artificial intelligence governance module 110 is responsible for analyzing the user prompts and identifying specific risks. It likely uses predefined algorithms, rules, or models to classify and categorize different types of risks. The risk identification module is designed to classify risks that are predefined or configured by the system. This suggests that the system has specific criteria for what is considered a risk, and the module adheres to these configurations. Once the risk identification module completes its analysis, the Neural network with attention based artificial intelligence governance module 110 takes the output generated by the risk identification process. This output likely contains information about the identified risks and their characteristics. The Neural network with attention based artificial intelligence governance module 110 uses the output from the risk identification module to provide a comprehensive risk analysis. This analysis is specifically based on customer inputs and AI generated answers indicating that the identified risks are contextualized and presented in a way that aligns with the specific inputs or queries made by users and response provided by AI systems.

In some embodiments, the pretrained Neural network with attention based artificial intelligence model equipped with a risk identification module configured to take customer prompts as input, a risk mitigation module designed to identify and mitigate risks against defined policies, a risk mitigatory module responsible for obtaining customer's informed consent based on the identified and mitigated risks before forwarding the customer prompts to downstream AI models and a bias detection module trained for bias detection, harmful content detection module which is trained for identifying malicious, illegal and dangerous content in completions or responses from downstream AI models. Specifically, this is the core AI model that has been pre-trained on a large dataset, giving it a baseline understanding of various patterns and features in data.

The processing subsystem 50 further includes a session management module 120 configured to facilitate seamless communication and integration with the plurality of Neural network with attention based artificial intelligence models by defining standardized application programming interface (API) endpoints. In one embodiment, the session management module 120 is facilitated by application programming interface (API)-based integration with the downstream AI model, wherein the integration allows conditional forwarding of prompts based on the risks identified, mitigated, and customized governance configurations established at the entity level. In detail, the session management module 120 is configured in a way that it promotes smooth and uninterrupted communication and integration between different components, specifically with a plurality of Neural network with attention based artificial intelligence models. The session management module 120 defines standardized API endpoints as a key feature has the ability of the session management module to define standardized Application Programming Interface (API) endpoints. Standardization ensures a consistent and uniform interface for interaction with the Neural network with attention based AI models. The session management module 120 is facilitated by API-based integration with downstream AI models. This implies that communication and interaction with these downstream models are structured and governed by APIs. The integration facilitated by the session management module 120 allows for conditional forwarding of prompts. This means that, based on certain conditions, the system may selectively forward user prompts to downstream AI models. The conditions for forwarding prompts are based on a series of criteria, including the risks identified and mitigated by the system. Additionally, customized governance configurations established at the entity level play a role in determining whether certain prompts should be forwarded. The session management module 120 allows for customized governance configurations at the entity level. Entities (which could be organizations or entities within an organization) can define specific configurations that govern the conditions for forwarding prompts, providing a high degree of flexibility.

Additionally, the processing subsystem 50 also includes a dashboard module 130 configured to summarize and present information related to the plurality of activities and providing an overview of the responsible usage of the plurality of Neural network with attention based artificial intelligence models within the organization. In one embodiment, the dashboard module 130 configured to generate a dashboard summary comprising all identified risks, accessible for review by the responsible AI officer, the board, the governance team, and individual users based on approved levels of access. Precisely, the dashboard module 130 designed to aggregate and present information related to a plurality of activities within the organization. The primary function of the dashboard module 130 is to summarize and present information. This includes data related to the activities of the Neural network with attention based artificial intelligence models. The dashboard module 130 provides an overview specifically focused on the responsible usage of the Neural network with attention based artificial intelligence models within the organization. This suggests that the dashboard emphasizes ethical and accountable AI practices. In one embodiment, the dashboard module 130 is configured to generate a summary. This indicates that the dashboard is dynamic and capable of presenting a concise overview of relevant information. The generated dashboard summary includes information about all identified risks. This feature provides a comprehensive view of potential issues or challenges associated with the usage of the Neural network with attention based AI models. The dashboard summary is accessible for review by key stakeholders, including the responsible AI officer, the board, the governance team, and individual users. This ensures that relevant parties have visibility into the identified risks and the overall responsible usage of AI. Access to the dashboard summary is governed by approved levels of access. This implies that different stakeholders may have varying levels of access permissions, ensuring that sensitive information is shared appropriately.

In a specific embodiment, the processing subsystem 50 includes a regulatory requirements module 140 which is configured to provide pre-defined packages of regulatory requirements. The pre-defined packages define controls and protection for user engagement with the plurality of Neural network with attention based artificial intelligence models. The pre-defined packages are selected by one or more entities based on geography of operation or compliance requirements, enabling a tailored and regulatory-compliant engagement. In detail, the regulatory requirements module 140 is configured to offer pre-defined packages of regulatory requirements. These packages serve as sets of guidelines, classifications, recommendations, controls, logging, reporting and protections to ensure compliance with relevant regulations. Within the pre-defined packages, there are specific controls and protection mechanisms. These are measures put in place to govern user engagement with the Neural network with attention based artificial intelligence models, ensuring that activities align with regulatory standards. Entities (organizations or users) have the ability to select pre-defined packages based on specific criteria. The criteria could include the geography of operation or specific compliance requirements relevant to the industry or region. The selection of pre-defined packages allows for a tailored and regulatory-compliant engagement. This means that entities can customize their approach to engagement with the Neural network with attention based AI models, ensuring alignment with applicable regulations.

The system 10 also includes at least one downstream artificial intelligence module 170, configured to be executed by the at least one processor. The downstream artificial intelligence module 170, while may be capable of answering prompts like any other Neural network with attention based model helping users get answers or resources generated for their prompts, but it may not be trustworthy enough for the users or enterprises to expose their sensitive data and queries if its external and risky to expose it to malicious queries if its internal. The downstream artificial intelligence module 170 may not be compliant with regulatory requirements like Privacy Preservation, Accountable usage, User safety, Model Security, Fair and unbiased response, Explainability of its responses, Reliable results and sustainability goals. Any downstream artificial intelligence module 170, whether internal or external, may need to be augmented for responsible AI principles with a responsible AI based AI governance system in a maker-checker model with this disclosed system.

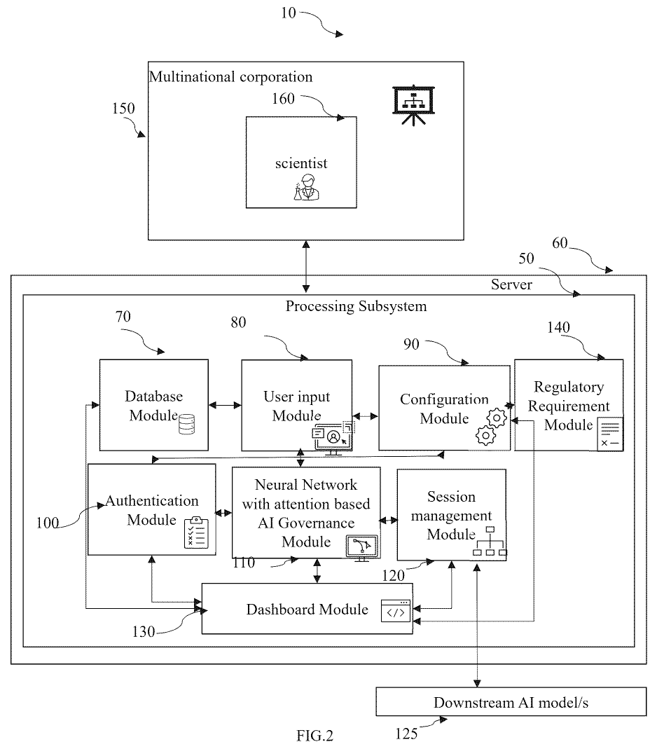

FIG. 2 is a schematic representation of an exemplary embodiment of the system (10) for artificial intelligence governance platform for responsible artificial intelligence of FIG. 1 in accordance with an embodiment of the present disclosure. Consider an example where a large multinational corporation 150 embracing cutting-edge Neural network with attention based artificial intelligence (AI) technologies to drive innovation and efficiency. To ensure responsible and ethical AI usage across its diverse operations, the corporation implements a robust artificial intelligence governance platform. This platform is a comprehensive system 10 designed to govern the interaction with the interactive platform utilized by the organisation and utilization of a myriad of Neural network with attention based AI models deployed throughout the organization.

The system 10 includes a powerful processing subsystem 50 hosted on a secure server 60. This processing subsystem 50 orchestrates bidirectional communications among various modules to ensure seamless integration and control over the AI infrastructure. A dedicated database module 70 receives, stores, and manages a wealth of activities related to the interaction and querying of Neural network with attention based AI models. This includes user interactions, queries, and outcomes, forming a comprehensive repository for analysis and monitoring. Users across the organization engage with the AI models through a user input module 80. This module receives input prompts from users intending to interact with the Neural network with attention based AI models via user interfaces (UI) or application programming interfaces (API), promoting user-friendly interactions. A sophisticated configuration module 90 defines organizational policies and regulatory requirements. These policies govern the responsible usage of AI models, specifying rules, constraints, and guidelines to align AI practices with organizational values and legal standards. An authentication module 100 plays a pivotal role in regulating and restricting access to AI models based on users' roles within the organization. Granular permission sets ensure that each user accesses only the information relevant to their responsibilities. A Neural network with attention based artificial intelligence governance module 110 utilizes a pre-trained and finetuned Neural network with attention based AI model to classify risks present in user input prompts. This proactive approach identifies potential risks associated with AI interactions, allowing for pre-emptive risk management. Ensuring seamless communication, a session management module defines standardized API endpoints, facilitating smooth integration with a multitude of downstream artificial intelligence module 170. This enhances interoperability and cohesion within the AI ecosystem. A dashboard module 120 provides a summarized overview of activities related to AI usage. It condenses information and presents key insights, offering a visual representation of the responsible usage of Neural network with attention based AI models across the organization.

In a real-time scenario, a data scientist 160 within the organization uses the system to query a Neural network with attention based AI model for predictive analytics. The user input module 80 receives the data scientist's prompt through a user-friendly interface. Simultaneously, the Neural network with attention based artificial intelligence governance module 110 analyzes the input to identify any potential ethical or compliance risks, providing instant feedback. The session management module 120 ensures that the query seamlessly integrates with the AI model through standardized API endpoints. The database module 70 records the interaction for future analysis, contributing to the organization's ongoing commitment to transparency and accountability. As the AI model processes the query, the Neural network with attention based artificial intelligence governance module 110 continues to monitor for any unexpected risks. The dashboard module 130 updates in real-time, summarizing the ongoing activity and providing stakeholders with a clear overview of the responsible and compliant usage of AI models within the organization. In parallel, the configuration module 90 ensures that the interaction adheres to predefined organizational policies and regulatory requirements, safeguarding against misuse or ethical concerns. The authentication module 100 verifies the data scientist's credentials and grants access based on their role, maintaining a secure and controlled environment. In this way, the artificial intelligence governance platform operates in real-time, harmonizing user interactions with Neural network with attention based AI models while proactively managing risks and providing a transparent overview of responsible AI usage across the organization.

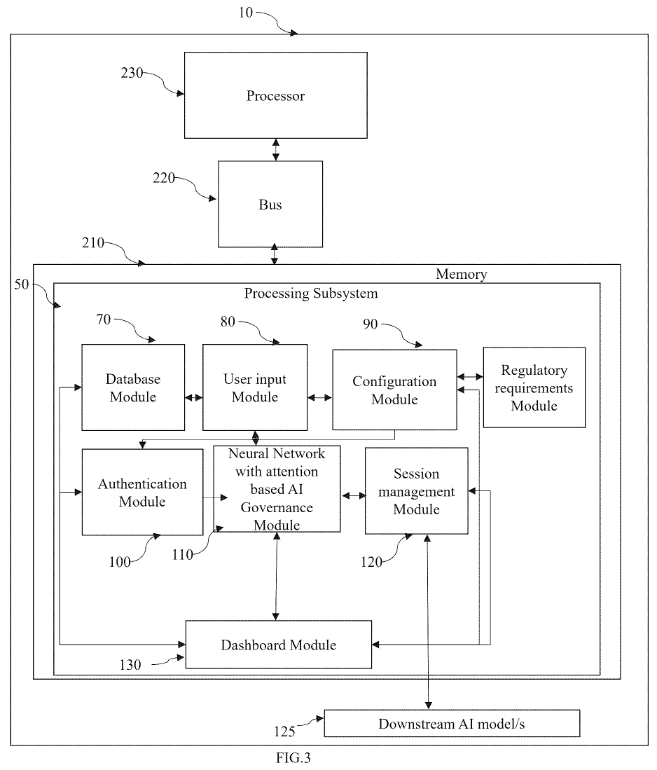

FIG. 3 is a block diagram of a computer or a server in accordance with an embodiment of the present disclosure. The server 200 includes processor(s) 230, and memory 210 operatively coupled to the bus 220. The processor(s) 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 210 includes several subsystems stored in the form of executable program which instructs the processor 230 to perform the method steps illustrated in FIG. 1. The memory 210 includes a processing subsystem 105 of FIG. 1. The processing subsystem 105 further has following modules: a database module 70, a user input module 80, a configuration module 90, an authentication module 100, a Neural network with attention based artificial risk visualisation module 110, a session management module 120, a dashboard module 130 and a regulatory requirements module 140.

The processing subsystem includes a database module configured to receive, store, and manage a plurality of activities related to the interaction and querying of a plurality of Neural network with attention based artificial intelligence models. The processing subsystem also includes a user input module configured to receive one or more input prompts from a user intending to interact the plurality of Neural network with attention based artificial intelligence models via at least one of an application programming interface (API) and a user interface (UI). The processing subsystem further includes a configuration module configured to define a plurality of organizational policies and regulatory requirements for governing usage of the plurality of Neural network with attention based artificial intelligence models in a responsible way in an organization by defining rules, constraints, and guidelines. The processing subsystem further includes an authentication module configured to regulate and restrict access of one or more users to the plurality of Neural network with attention based artificial intelligence models based on corresponding roles within the organization by providing granular permission sets. The processing subsystem further includes a Neural network with attention based artificial intelligence governance module configured to configured to classify configured risks present in the one or more input prompts received from the user using a pre-trained Neural network with attention based artificial intelligence model. The processing subsystem further includes a session management module configured to facilitate seamless communication and integration with the plurality of downstream artificial intelligence models by defining standardized application programming interface (API) endpoints, the response of downstream AI model is validated for bias and other potential harms mentioned by regulators or configured by user is identified by Neural network with attention based artificial intelligence governance module before showcasing the result to the user. The processing subsystem further includes a dashboard module configured to summarize and present information related to the plurality of activities and providing an overview of the responsible usage of the plurality of Neural network with attention based artificial intelligence models within the organization.

The bus 220 as used herein refers to be internal memory channels or computer network that is used to connect computer components and transfer data between them. The bus 220 includes a serial bus or a parallel bus, wherein the serial bus transmits data in bit-serial format and the parallel bus transmits data across multiple wires. The bus 220 as used herein, may include but not limited to, a system bus, an internal bus, an external bus, an expansion bus, a frontside bus, a backside bus and the like.

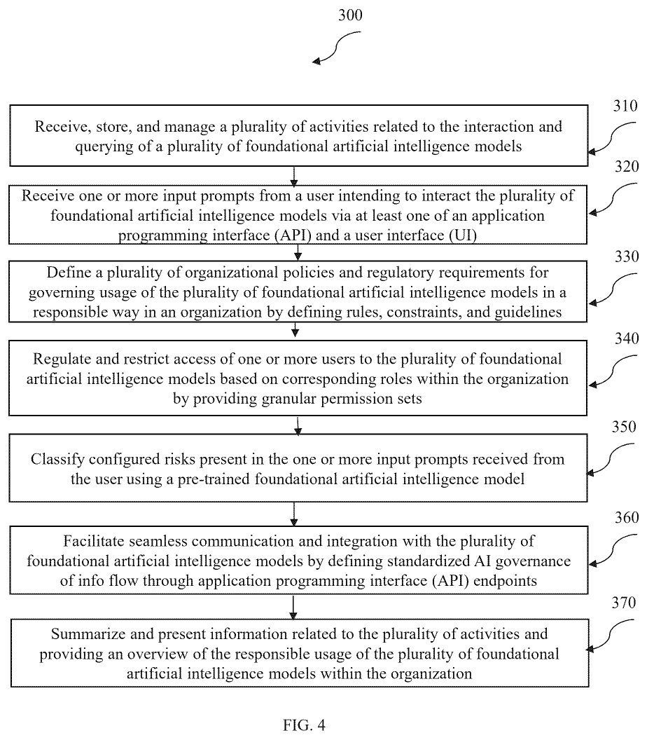

FIG. 4 is a flow chart representing the steps involved in a method 300 for dynamic client registration and open application programming interface request flow of FIG. 1 in accordance with an embodiment of the present disclosure. The method 300 includes receiving, storing, and managing, by a database module, a plurality of activities related to the interaction and querying of a plurality of Neural network with attention based artificial intelligence models in step 310. In one embodiment, receiving, storing, and managing may include receiving responses from a downstream artificial intelligence model, wherein the responses are verified for harm and stored in a database module for retrieving stored responses from the database and sharing them with the front-end system for user consumption.

The method 300 further includes receiving, by a user input module, one or more input prompts from a user intending to interact the plurality of Neural network with attention based artificial intelligence models via at least one of an application programming interface (API) and a user interface (UI) in step 320. In one embodiment, receiving the one or more input prompts may include facilitating seamless interaction between the one or more users and the plurality of Neural network with attention based artificial intelligence models, by processing and relaying the one or more inputs prompts to enhance the user experience with the plurality of Neural network with attention based artificial intelligence models.

The method 300 further includes defining, by a configuration module, a plurality of organizational policies and regulatory requirements for governing usage of the plurality of Neural network with attention based artificial intelligence models in a responsible way in an organization by defining rules, constraints, and guidelines in step 330. In one embodiment, defining the plurality of organizational policies and regulatory requirements may include adding the security and privacy layer, wherein adding the security and privacy layer comprising an adaptive mechanism configured to dynamically adjust access controls and encryption protocols based on the user's interaction with the plurality of Neural network with attention based artificial intelligence models, thereby enhancing user privacy and safeguarding against potential security threats. In such an embodiment, defining the plurality of organizational policies and regulatory requirements may include accepting configurations from an entity, wherein the configurations define rules of engagement for the one or more users interacting with the plurality of Neural network with attention based artificial intelligence models, thereby allowing customization and specification of user interactions based on the preferences and requirements of the entity.

The method 300 further includes regulating and restricting, by an authentication module, access of one or more users to the plurality of Neural network with attention based artificial intelligence models based on corresponding roles within the organization by providing granular permission sets in step 340. In one embodiment, regulating and restricting may include deriving responsible artificial intelligence based engagement requirement policies for the one or more users based on corresponding roles, thereby facilitating personalized and role-specific interactions with the plurality of Neural network with attention based artificial intelligence models. In a specific embodiment, the method 300 includes providing pre-defined packages of regulatory requirements, wherein the pre-defined packages define controls and protection for user engagement with the plurality of Neural network with attention based artificial intelligence models, and wherein the pre-defined packages are selected by one or more entities based on geography of operation or compliance requirements, enabling a tailored and regulatory-compliant engagement.

The method 300 further includes classifying, by a Neural network with attention based artificial intelligence risk visualisation module, risks present in the one or more input prompts received from the user using a pre-trained Neural network with attention based artificial intelligence model in step 350. In one embodiment, classifying the risks may include designating the pretrained Neural network with attention based artificial intelligence model to receive user prompts as input, featuring a risk identification module responsible for classifying configured risks, and the Neural network with attention based artificial intelligence governance module that shares the output, providing a comprehensive risk analysis based on customer inputs, wherein the pretrained Neural network with attention based artificial intelligence model equipped with a risk identification module is taking customer prompts as input or completions from downstream artificial intelligence module, a risk mitigation module designed to identify and mitigate risks against defined policies, and a risk mitigatory module responsible for obtaining customer's informed consent based on the identified and mitigated risks before forwarding the customer prompts to downstream AI models. The downstream AI Model may not be compliant with regulatory requirements like Privacy Preservation, Accountable usage, User safety, Model Security, Fair and unbiased response, Explainability of its responses, Reliable results and sustainability goals. Any downstream artificial intelligence module, whether internal or external, may need to be augmented for responsible AI principles with a responsible AI based AI Governance system in a maker-checker model with this disclosed system. The Neural network with attention based AI Risk visualisation module would analyse the data for Privacy Preservation, Accountable usage, User safety, Model Security, Fair and unbiased response, Explainability of its responses to improve, flag or block inappropriate responses and make user experience of LLMs Responsible AI compliant.

The method 300 further includes facilitating, by a session management module, seamless communication and integration with the plurality of Neural network with attention based artificial intelligence models by defining standardized application programming interface (API) endpoints in step 360. In one embodiment, facilitating the seamless communication and integration may include allowing conditional forwarding of prompts based on the risks identified, mitigated, potentially harmful information detection in downstream AI system's response before showcasing to user and customized governance configurations established at the entity level, wherein the session management module is facilitated by application programming interface (API)-based integration with the downstream AI model.

The method 300 further includes summarizing, by a dashboard module, and presenting information related to the plurality of activities and providing an overview of the responsible usage of the plurality of Neural network with attention based artificial intelligence models within the organization in step 370. In one embodiment, summarizing and presenting information may include generating a dashboard summary comprising all identified risks, accessible for review by the responsible AI officer as human in the loop feedback, the board, the governance team, and individual users based on approved levels of access.

Various embodiments of the present disclosure provide a system for artificial intelligence governance platform for responsible artificial intelligence described above enables a regulatory requirements module that provides pre-defined packages of regulatory requirements. These packages include controls and protections for user engagement with Neural network with attention based artificial intelligence models. Entities can select these pre-defined packages based on factors such as geography of operation or specific compliance requirements, enabling a tailored and regulatory-compliant engagement. This approach enhances flexibility while ensuring that engagements with AI models adhere to regulatory standards. The system further provides the dashboard module that summarizes and presents information related to the activities of Neural network with attention based artificial intelligence models, with a specific focus on responsible usage within the organization. The dashboard summary, including identified risks, is accessible to key stakeholders based on approved levels of access, promoting transparency and accountability in AI governance.

The system also provides a system with a session management module that facilitates seamless communication and integration with Neural network with attention based artificial intelligence models through standardized API endpoints. The integration is further enhanced by API-based connectivity with downstream AI models, allowing conditional forwarding of prompts based on identified risks, mitigations, and customized governance configurations established at the entity level. The system is designed to offer flexibility and customization in handling communication within the AI ecosystem. The pretrained Neural network with attention based artificial intelligence model incorporates specialized modules for risk identification and mitigation, with a dedicated focus on customer prompts. It operates based on defined policies, seeks informed consent from customers, and ensures that risks are addressed before further processing by downstream AI models. This comprehensive approach is designed to enhance the system's transparency, accountability, and ethical use.

The system leverages a Neural network with attention based AI Risk Visualisation Module that is configured to use a pretrained Neural network with attention based AI model with a risk identification module. The overall process involves analyzing user prompts, identifying configured risks, and presenting a comprehensive risk analysis based on the specific inputs provided by customers. This approach enhances the system's ability to communicate identified risks to users in a way that is tailored to their interactions and needs. The integration of the authentication module helps ensure that user engagements align with ethical and regulatory considerations, fostering a responsible and accountable use of artificial intelligence within the system.

Furthermore, the configuration module acts as a flexible and adaptable tool within the system, ensuring that the behavior of users interacting with Neural network with attention based AI models can be finely tuned and aligned with the overarching goals and guidelines set by the external entity. This level of configurability allows for a more personalized and controlled user experience, catering to the specific needs and constraints defined by the entity that owns or operates the AI system.

Generative AI or transformer-based architectures have gained significant interest for their effectiveness in various natural language processing (NLP) tasks. But there are very poor in the aspects of usage and governance of AI in relation to privacy, accountability, safety, security, fairness, explainability and reliability, making the need for Responsible AI very acute. The present invention discloses neural network with attention modules tailored for control of prompts or information flow to enable AI governance for responsible AI deployment and usage. The disclosed AI governance system will act like an AI proxy or a firewall between users and the downstream AI models by governing the bidirectional information flow including prompts and responses or information flow. Thus, providing safe, secure and responsible AI experience to users.

The processor used may be a CPU or GPU or a combination of both. Traditional Large Language Models are processor hungry, mandatorily requiring GPUs to be present. But in the current disclosure, an efficient neural network architecture with attention for Responsible AI Governance is disclosed, which in an embodiment may be small language model, which may run on both CPU or a GPU or a hybrid processing architecture, adding high level of efficiency and scalability to the system.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A computer implemented system for artificial intelligence governance platform for responsible artificial intelligence comprising:
at least one processor in communication with a client processor; and
at least one memory comprises a set of program instructions in the form of a processing subsystem, configured to be executed by the at least one processor, wherein the processing subsystem is hosted on a server and configured to execute on a network to control bidirectional communications among a plurality of modules comprising:
a database module configured to receive, store, and manage a plurality of activities related to the interaction and querying of a plurality of Neural network with attention based artificial intelligence models;
a user input module configured to receive one or more input prompts from a user intending to interact the plurality of Neural network with attention based artificial intelligence models via at least one of an application programming interface (API) and a user interface (UI);
a configuration module configured to define a plurality of organizational policies and regulatory requirements for governing usage of the plurality of Neural network with attention based artificial intelligence models in a responsible way in an organization by defining rules, constraints, and guidelines;
an authentication module configured to regulate and restrict access of one or more users to the plurality of Neural network with attention based artificial intelligence models based on corresponding roles within the organization by providing granular permission sets;
a Neural network with attention based artificial intelligence governance module configured to configured to classify configured risks present in the one or more input prompts and output completions received from the user using a pre-trained Neural network with attention based artificial intelligence model;
a session management module configured to facilitate seamless communication and integration with the plurality of Neural network with attention based artificial intelligence models by defining standardized application programming interface (API) endpoints; and
a dashboard module configured to summarize and present information related to the plurality of activities and providing an overview of the responsible usage of the plurality of Neural network with attention based artificial intelligence models within the organization.

2. The system as claimed in claim 1, wherein the configuration module is configured to add the security and privacy layer comprising an adaptive mechanism configured to dynamically adjust access controls and encryption protocols based on the user's interaction with the plurality of Neural network with attention based artificial intelligence models, thereby enhancing user privacy and safeguarding against potential security threats.

3. The system as claimed in claim 1, wherein the user input module is configured to facilitate seamless interaction between the one or more users and the plurality of Neural network with attention based artificial intelligence models, by processing and relaying the one or more inputs prompts to enhance the user experience with the plurality of Neural network with attention based artificial intelligence models.

4. The system as claimed in claim 1, wherein the configuration module configured to accept configurations from an entity, wherein the configurations define rules of engagement for the one or more users interacting with the plurality of Neural network with attention based artificial intelligence models, thereby allowing customization and specification of user interactions based on the preferences and requirements of the entity.

5. The system as claimed in claim 1, wherein the processing subsystem comprises a regulatory requirements module configured to provide pre-defined packages of regulatory requirements, wherein the pre-defined packages define controls and protection for user engagement with the plurality of Neural network with attention based artificial intelligence models, and wherein the pre-defined packages are selected by one or more entities based on geography of operation or compliance requirements, enabling a tailored and regulatory-compliant engagement.

6. The system as claimed in claim 1, wherein the authentication module integrated with the one or more entities', configured to derive responsible artificial intelligence based engagement requirement policies for the one or more users based on corresponding roles, thereby facilitating personalized and role-specific interactions with the plurality of Neural network with attention based artificial intelligence models.

7. The system as claimed in claim 1, wherein the Neural network with attention based artificial intelligence governance module is configured to designate the pretrained Neural network with attention based artificial intelligence model to receive user prompts as input, featuring a risk identification module responsible for classifying configured risks, and the Neural network with attention based artificial intelligence governance module that shares the output, providing a comprehensive risk analysis based on customer inputs.

8. The system as claimed in claim 7, wherein the pretrained Neural network with attention based artificial intelligence model equipped with a risk identification module configured to take customer prompts as input, a risk mitigation module designed to identify and mitigate risks against defined policies, and a risk mitigatory module responsible for obtaining customer's informed consent based on the identified and mitigated risks before forwarding the customer prompts to downstream AI models.

9. The system as claimed in claim 1, wherein the Neural network with attention based artificial intelligence governance module comprises a small language model configured to provide responsible artificial intelligence controls to implement technical guardrails to make interaction and deployment of large language model privacy preserved, accountable, safe, secure, fair, explainable, reliable and sustainable.

10. The system as claimed in claim 1, wherein the session management module is facilitated by application programming interface (API)-based integration with the downstream AI model, wherein the integration allows conditional forwarding of prompts based on the risks identified, mitigated, and customized governance configurations established at the entity level.

11. The system as claimed in claim 1, wherein the database module is configured to receive responses from a downstream artificial intelligence model, wherein the responses are stored in a database module for retrieving stored responses from the database and sharing them with the front-end system for user consumption.

12. The system as claimed in claim 1, wherein the dashboard module configured to generate a dashboard summary comprising all identified risks, accessible for review by the responsible AI officer, the board, the governance team, and individual users based on approved levels of access.

13. The system as claimed in claim 1, wherein the processing subsystem comprises at least one downstream artificial intelligence module, configured to:
answer prompts like any other Neural network with attention based model helping users get answers or resources generated for their prompts; and
augment for responsible artificial intelligence principles with a responsible artificial intelligence based artificial intelligence governance system in a maker-checker model.

14. A method comprising:
receiving, storing, and managing, by a database module, a plurality of activities related to the interaction and querying of a plurality of Neural network with attention based artificial intelligence models;
receiving, by a user input module, one or more input prompts from a user intending to interact the plurality of Neural network with attention based artificial intelligence models via at least one of an application programming interface (API) and a user interface (UI);
defining, by a configuration module, a plurality of organizational policies and regulatory requirements for governing usage of the plurality of Neural network with attention based artificial intelligence models in a responsible way in an organization by defining rules, constraints, and guidelines;
regulating and restricting, by an authentication module, access of one or more users to the plurality of Neural network with attention based artificial intelligence models based on corresponding roles within the organization by providing granular permission sets;
classifying, by a Neural network with attention based artificial intelligence risk visualisation module, risks present in the one or more input prompts received from the user using a pre-trained Neural network with attention based artificial intelligence model;
facilitating, by a session management module, seamless communication and integration with the plurality of Neural network with attention based artificial intelligence models by defining standardized application programming interface (API) endpoints; and
summarizing, by a dashboard module, and present information related to the plurality of activities and providing an overview of the responsible usage of the plurality of Neural network with attention based artificial intelligence models within the organization.
